(19) United States
(12) Patent Application Publication
(10) Pub. No.: US 2006/0072820 A1
(43) Pub. Date: Apr. 6, 2006

(54) System and method for checking framing and sharpness of a digital image

(75) Inventors: Niko Porjo, Turku (FI); Trimeche Mejdi, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/958,612

(22) Filed: Oct. 5, 2004

(51) Int. Cl. G06K 9/34; G06K 9/32

(52) U.S. Cl. 382/173; 382/298

(57) ABSTRACT

A system and method for providing both sharpness and framing information of a digital image to a user. An original image is captured and processed by an electronic device. At the same time, a portion of the original image is selected, cropped and processed to create a final zoomed image. The final zoomed image and the processed original image are simultaneously displayed to the user, permitting the user to use the final zoomed image to determine the relative sharpness of the original image.

### FIELD OF THE INVENTION

The present invention relates generally to digital photographs. More particularly, the present invention relates to systems and methods for determining the quality of digital images.

### BACKGROUND OF THE INVENTION

In recent years, digital cameras have increased in popularity, both as stand-along products and as part of other devices such as cellular telephones, personal digital assistants and other devices.

When a digital image is taken with a digital camera, the framing and sharpness of the image needs to be checked. “Framing” refers to ensuring that the intended target has been successfully captured in the image. “Sharpness” refers to the level of form and detail of the image that has been captured. Framing is usually easy to check by the user by examining a preview or thumbnail image that is shown on the camera's display.

Unlike framing issues, however, the sharpness of a digital image usually cannot be carefully observed and examined in a small preview image. Unfortunately, there are several factors which could easily degrade the sharpness of image. Long exposure times, a large optical zoom, the selection of auto focus distance, the moving of the camera during the picture-taking process, a large aperture and/or a combination of these factors can all cause the image or parts of it to be blurred. Unless the image is badly blurred, if the user wishes to examine the thumbnail image for sharpness issues, the user must zoom into the image so that individual pixels are displayed one-on-one with the display pixels.

Zooming into a picture, however, is extremely time consuming. In fact, this process is so time consuming that even those who recognize that sharpness issues can occur usually do not zoom into the image. Instead, such users take several images and hope that some have a satisfactory degree of sharpness. On the other hand, when several different pages are imaged with a document camera application, it is often impractical to either use the zoom (due to the time issues discussed above) or to take several images per page due to frequent memory limitations and the extra work that is usually involved in deleting unnecessary images.

If multiple images are taken and the decision on the picture quality is made from the normal preview image, it is very possible that the user will discard the sharper image. For example, in FIG. 1, two 1152 pixel wide images have been resized using a popular conventional software program to 208 pixel-wide images. As can be clearly observed, the left image looks much less sharp than the right image, even though the original version of the left image is actually much sharper than the right image. In this instance, the difference in quality is due to bad algorithms used in the software program. There are a number of other potential scenarios where similar types of distortion may also occur.

### SUMMARY OF THE INVENTION

The present invention is directed to a system and method for enabling a user to easily and quickly examine both the framing and sharpness of a preview image. In the present invention, the framing and sharpness is shown in the same image. This is achieved by enlarging a portion of the image and embedding it in the original image such that both the original image and the selected portion can be reviewed and examined by the user. Various types of intelligence software can be used to select an appropriate section of the image for enlargement such that the sharpness of the image can be easily analyzed by the user.

The present invention provides a number of advantages over conventional systems. In the present invention, a user does not need to manually zoom into a portion of the image in order to make a sharpness determination. The present invention allows the user to only take a single image of an object without having to “guess” whether the image is of a satisfactory quality, potentially opening up additional file space for later pictures. This can be especially important when images are taken of documents containing text, where the image can be extremely large in size and the sharpness of the text is of special importance.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 shows a pair of 1152 pixel wide images that have been resized to 208 pixel-wide images, causing the higher-quality left image to appear of inferior quality relative to the right image;

FIG. 2 is a sectional side view of a generic digital camera according to the principles of the present invention;

FIG. 3 is a flow chart showing the steps involved in the implementation of one embodiment of the present invention;

FIG. 4 shows a preview image according to the principles of the present invention, wherein a portion of the preview image has been selected and enlarged for examination by the user;

FIG. 5 shows a preview image according to the principles of the present invention, wherein a picture inside the preview image has been selected and enlarged for examination the user;

FIG. 6 shows a preview image of a text document with a portion thereof enlarged for the user, wherein the enlarged portion shows that the document is unreadable; and

FIG. 7 shows a preview image of a text document with a portion thereof enlarged for the user, wherein the enlarged portion shows that the document is readable.

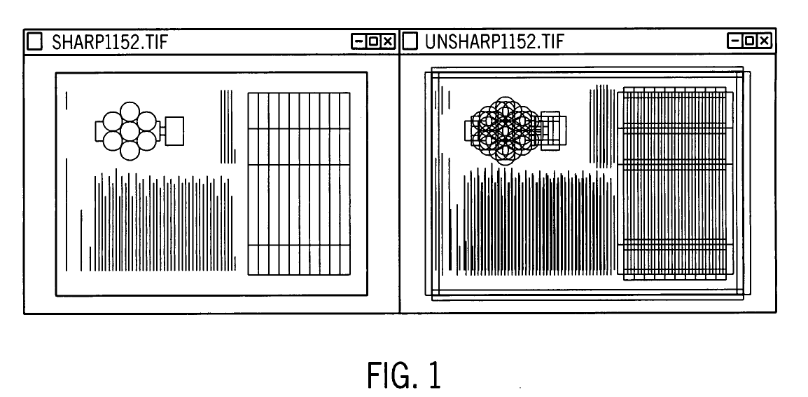

### DETAILED DESCRIPTION OF THE PREFERRED EMBODIMENTS

The present invention permits a digital camera to show both the framing and sharpness of a captured digital image in a single preview image. This is achieved by enlarging a small part of the image and embedding it in the original image. For optimum results, intelligent software is used when selecting the portion of the image that is to be enlarged. For example, when a text document is imaged, text recognition algorithms can be used. In other instances, edge detection algorithms may be used to find places where the sharpness is easy to analyze. Other suitable methods may also be used, and in some applications, the exact method to be used may be selectable by the user.

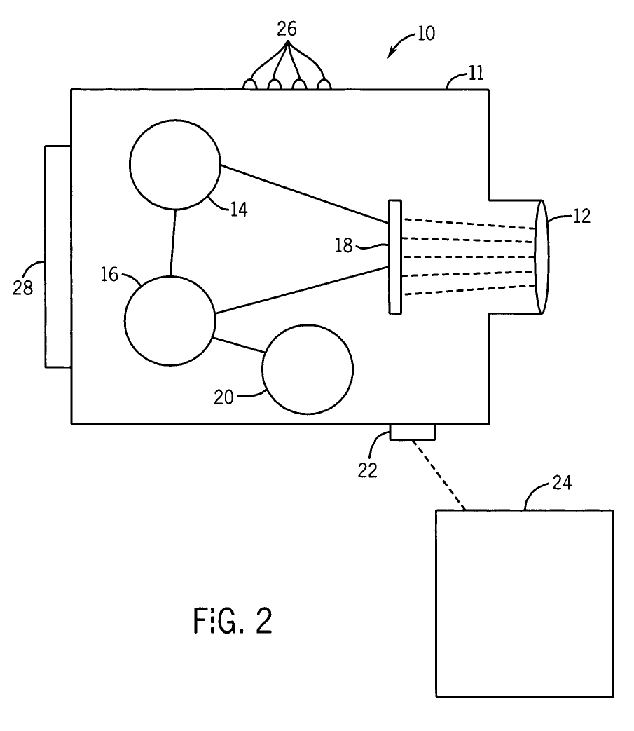

A generic digital camera according to the principles of the present invention is shown at 10 in FIG. 2. The digital camera 10 can be a stand-alone device or can be incorporated into another electronic device, such as a portable telephone. The digital camera 10 includes a housing 11 which contains at least one focusing element 12, a primary memory unit 14, a processor 16, and at least one image sensor 18. In one embodiment of the invention, the focusing element 12 comprises a lens. However, it is also possible for the digital camera 10 to not include a lens at all, instead using other types of light gathering and focusing devices such as a pin hole (not shown). The primary memory unit 14 can be used to store digital images and computer software for performing various functions in the digital camera, as well as to implement the present invention. A removable, secondary memory unit 20 in the form of a memory card can also be included in the digital camera to provide extra memory space according to one embodiment of the invention. It should also be noted that some cameras, such as those having BlueTooth technology, may not have frame-sized memory. The image sensor 18 can be a charge coupled device (CCD), a complementary metal oxide semiconductor (CMOS), or another system.

When a digital picture is taken, the at least one focusing element 12 focuses the image onto the at least one image sensor 18 which records light either electronically or by some other mechanism. The processor 16 then breaks this electronic information down into digital data which can be stored on the primary memory unit 14 and/or the secondary memory unit 20. The digital camera 10 also includes a data communication port 22 to enable the transmission of digital images from the digital camera 10 to a remote terminal such as a personal computer 24. The data communication can be in either wired or wireless form and can be configured for USB, BlueTooth, infrared or other connections. The digital camera 10 includes one or more input buttons 26 for entering information and/or taking a picture, although input buttons 26 could also be remote from the digital camera 10. The digital camera 10 also includes a user interface 28 through which a user can view preview or thumbnail images, view and alter menu options, and perform other functions. In one embodiment of the invention, the user interface 28 takes the form of a liquid crystal display.

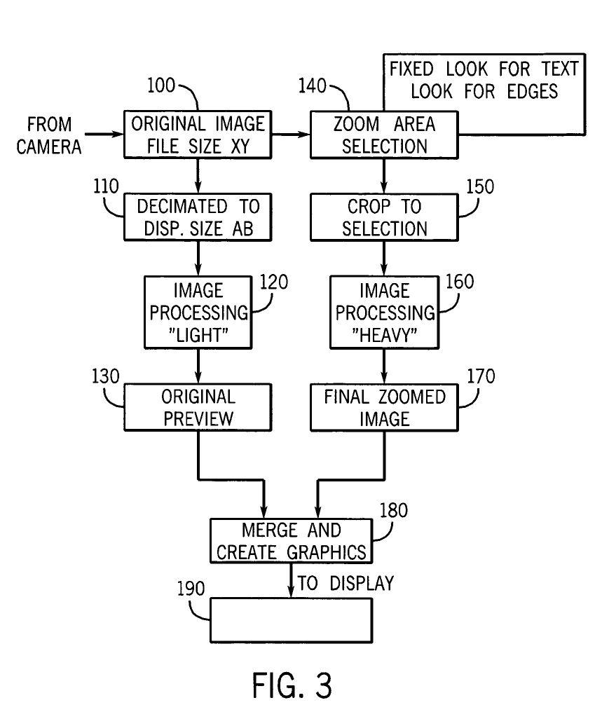

FIG. 3 shows the process for simultaneously providing a user with both sharpness and framing information within the same preview image according to one embodiment of the present invention. At step 100, an original image is captured by the digital camera 10. In this particular embodiment of the invention, the data comes from a digital camera 10, but it is also possible that the data can come from any compatible data structure. For example, the image could be transmitted to the user via electronic mail, instant message, or another system. At step 100, the original image has a file size of “xy.” In one embodiment of the invention, this corresponds to a 10-bit raw bayer “xy” as the original file size. This can be of particular importance for document camera and barcode applications.

At step 110, the original image is decimated to a dispersion size of “ab.” Before the image can be viewed by a user, the image size must be reduced to the size available on the user interface 28. At step 120, a “light” processing of the image occurs. It should also be noted that, if the digital camera 10 has sufficient processing power, as may be the case in a pro digital camera, the “light” processing can be the same processing that is used for all images. Raw bayer data often cannot be shown in a thumbnail image, so some processing is therefore required of the image. To make the delay from shutter release to first image as short as possible, processing is minimized according to one embodiment of the invention. Also, by processing the image after it has been decimated, the processing time is shortened. At step 130, an original preview image is formed as a result of the decimation and processing.

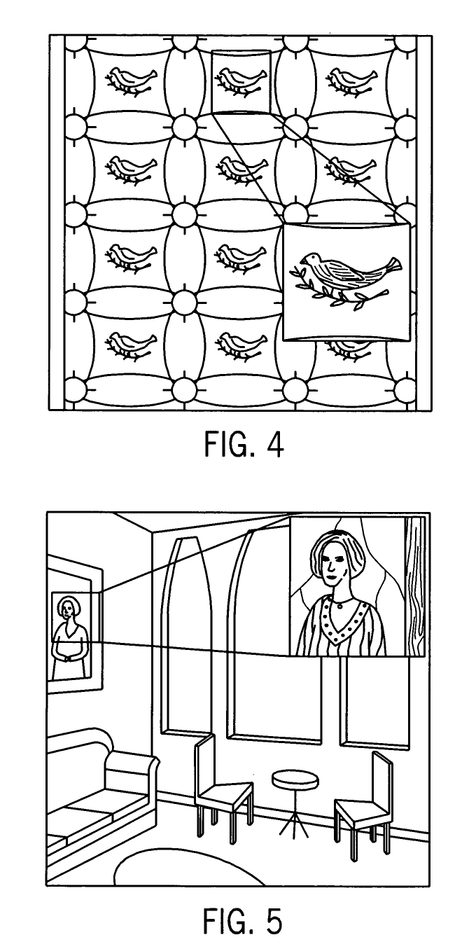

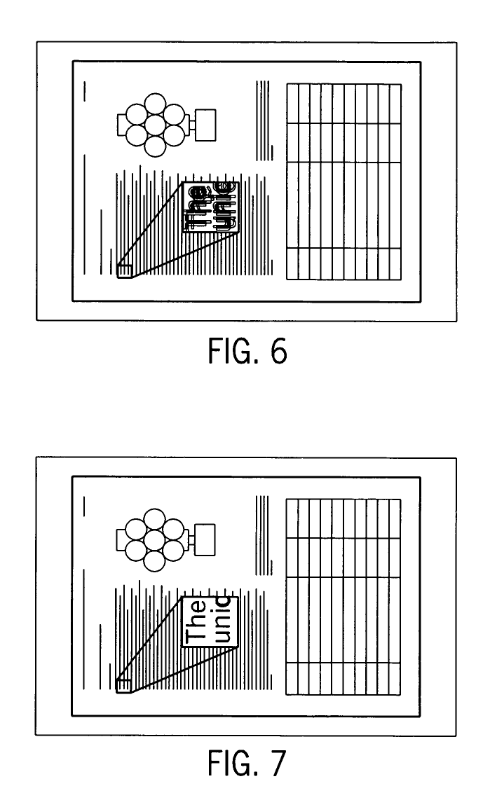

While the decimation and processing steps are occurring, at step 140 a zoom area of the original image is selected. A variety of different methods with different computational complexity can be used for this step. A fast method selection involves having a fixed location and size automatically selected by the computer software for each image. For example, the software can include program instructions to automatically include an upper right-hand portion of the original image for zooming. To the results of sharpness determination, various intelligence can be used. For example, text recognition algorithms can be used for text documents. FIGS. 6 and 7 show one embodiment of the present invention where computer software inside the digital camera 10 automatically looks for text that can be zoomed. Alternatively, for other images, edge detection algorithms may be used to find places where the sharpness is easy to judge. For example, FIGS. 4 and 5 show images where portions of the respective images having defined features are used for zooming. In an alternate embodiment of the invention, it is also possible to select several potential locations and allow the user browse through the prospective locations for zooming.

At step 150, the original image is cropped to the selected area. A new image with size “cd” is then formed. In one embodiment of the invention, this new image has dimensions in the range of tens of pixels wide and high. At step 160, a “heavy” image processing occurs, where the new image is processed as well as possible. Due to the small size of the image, the “heavy” processing times are short for this step. At step 170, a final zoomed image is formed. The sharpness of the original image is viewable in the final zoomed image. Additionally, if the image captured a text-containing document, the text should be readable in the final zoomed image if the sharpness is satisfactory.

At step 180, the final zoomed image is merged into the original preview image and graphics are added to show the user which is the final zoomed image and which portion of the original image it came from. FIGS. 4-7 all show examples of the final merged image. The graphics that are used to show where the final zoomed image originated can take a variety of forms. For example, a simple black and/or white dotted line may be preferable in text documents but might not be sufficient in color images. Additionally, the location where the final zoomed image is positioned can be predetermined, or a software intelligence algorithm can be used to avoid obscuring vital parts of the image. The final merged image is then ready to be displayed on the user interface 28 at step 190. All of the above-identified steps can be accomplished through computer software programs stored within the primary unit 14 and/or the secondary memory unit 20.

Once the final merged image has been displayed on the user interface 28, the user is capable of making a determination regarding the sharpness of the image. FIGS. 6 and 7 show a pair of final merged images that include text characters therein. In FIG. 6, it can be seen in the final zoomed image that the text of the original image is not readable. In this particular case, the image processing for the final zoomed image involved the use of “auto levels” in Adobe Photoshop 7.0.1, while the original image is a 6.1 megapixel image from a Canon 10D digital SLR, processing in Canon PC software. The original image was reduced to a width of 1152 pixels. This image was the resized from that intermediary image. All decimating was performed using the “Bicubic” method in Photoshop. FIG. 7 shows the same image with greatly improved sharpness, as can be easily observed in the final zoomed image.

With the system and method of the present invention, the user is capable of quickly and easily determining the sharpness of a captured image without manually entering into the captured image. The need for capturing multiple images of the same object can be greatly reduced or eliminated, resulting in a savings of time by the user and file space within the digital camera. The present invention can be incorporated into both stand-alone digital cameras and other types of electronic devices, regardless of whether the particular device even includes picture-taking capabilities.

While several embodiments have been shown and described herein, it should be understood that changes and modifications can be made to the invention without departing from the invention in its broader aspects. For example, but without limitation, the size of the final zoomed image could be altered or selected automatically or manually, and the portion of the original image to be zoomed can be selected by a wide variety of algorithms. Additionally, when the selection of a zoomed area is performed using a representative algorithm, it is also possible for the system to analyze the rest of the preview image to determine if similar conditions (such as similar sharpness) exists in other regions of the image. Furthermore, many steps discussed herein for implementing the present invention can be completed through the use either software or hardware applications. Various features of the invention are defined in the following Claims.

What is claimed is:

1. A method for providing sharpness and framing information from an image to a user, comprising the steps of:
providing an original image;
processing the original image;
selecting a portion of the original image;
cropping the selected portion;
processing the selected portion to create a final zoomed image; and
simultaneously displaying the processed original image and the final zoomed image on a user interface.

2. The method of claim 1, further comprising the step of providing graphical information concerning the location on the original image from which selected image was taken.

3. The method of claim 1, further comprising the step of decimating the original image such that the original image is displayable in its entirety on the user interface with the final zoomed image superimposed thereon.

4. The method of claim 1, wherein the selected portion of the original image is determined through the use of an edge detection algorithm.

5. The method of claim 1, wherein the selected portion of the original image is determined through the use of a text recognition algorithm.

6. The method of claim 1, wherein the selected portion of the original image is predetermined before the original image is provided.

7. The method of claim 1, wherein the selected portion of the original image is determinable by the user.

8. The method of claim 1, wherein the final zoomed image is superimposed on a portion of the processed original image.

9. A computer program product for providing sharpness and framing information from an image to a user, comprising:
computer code for providing an original image;
computer code for processing the original image;
computer code for selecting a portion of the original image;
computer code for cropping the selected portion;
computer code for processing the selected portion to create a final zoomed image; and
computer code for simultaneously displaying the processed original image and the final zoomed image on a user interface.

10. The computer program product of claim 9, further comprising computer code for providing graphical information concerning the location on the original image from which selected image was taken.

11. The computer program product of claim 9, further comprising computer code for decimating the original image such that the original image is displayable in its entirety on the user interface with the final zoomed image superimposed thereon.

12. The computer program product of claim 9, wherein the selected portion of the original image is determined through the use of an edge detection algorithm.

13. The computer program product of claim 9, wherein the selected portion of the original image is determined through the use of a text recognition algorithm.

14. The computer program product of claim 9, wherein the selected portion of the original image is predetermined before the original image is provided.

15. The computer program product of claim 9, wherein the selected portion of the original image is determinable by the user.

16. The computer program product of claim 9, wherein the final zoomed image is superimposed on a portion of the processed original image.

17. An electronic device, comprising:
a processor for processing image information;
a user interface; and
a memory unit operatively connected to the processor, the memory unit including a computer program product comprising:
computer code for providing an original image,
computer code for processing the original image,
computer code for selecting a portion of the original image,
computer code for cropping the selected portion,
computer code for processing the selected portion to create a final zoomed image, and
computer code for simultaneously displaying the processed original image and the final zoomed image on the user interface.

18. The electronic device of claim 17, further comprising a focusing system for capturing the original image.

19. The electronic device of claim 17, wherein the memory unit further comprises computer code for providing graphical information concerning the location on the original image from which selected image was taken.

20. The electronic device of claim 17, wherein the memory unit further comprises computer code for decimating the original image such that the original image is displayable in its entirety on a user interface along with the final zoomed image.

21. The electronic device of claim 17, wherein the selected portion of the original image is determined through the use of an edge detection algorithm.

22. The electronic device of claim 17, wherein the selected portion of the original image is determined through the use of a text recognition algorithm.

23. The electronic device of claim 17, wherein the selected portion of the original image is predetermined before the original image is provided.

24. The electronic device of claim 17, wherein the selected portion of the original image is determinable by the user.

25. The electronic device of claim 17, wherein the final zoomed image is superimposed on a portion of the processed original image on the user interface.

26. A module for use in providing sharpness and framing information from an image to a user, comprising:
a processor for processing image information; and
a memory unit operatively connected to the processor, the memory unit including a computer program product comprising:
computer code for providing an original image,
computer code for processing the original image,
computer code for selecting a portion of the original image,
computer code for cropping the selected portion,
computer code for processing the selected portion to create a final zoomed image, and
computer code for simultaneously displaying the processed original image and the final zoomed image on a user interface.

27. The module of claim 26, wherein the memory unit further comprises computer code for providing graphical information concerning the location on the original image from which selected image was taken.

28. The module of claim 26, wherein the memory unit further comprises computer code for decimating the original image such that the original image is displayable in its entirety on the user interface along with the final zoomed image superimposed thereon.

29. The module of claim 26, wherein the selected portion of the original image is determined through the use of an edge detection algorithm.

30. The module of claim 26, wherein the selected portion of the original image is determined through the use of a text recognition algorithm.

31. The module of claim 26, wherein the selected portion of the original image is predetermined before the original image is provided.

32. The module of claim 26, wherein the selected portion of the original image is determinable by the user.

33. The module of claim 26, wherein the final zoomed image is superimposed on a portion of the processed original image on the user interface.
